(19) United States
(12) Patent Application Publication
(10) Pub. No.: US 2002/0091678 A1
(43) Pub. Date: Jul. 11, 2002

(54) Multi-query data visualization processes, data visualization apparatus, computer-readable media and computer data signals embodied in a transmission medium

(76) Inventors: Nancy E. Miller, San Diego, CA (US); Elizabeth G. Hetzler, Kennewick, WA (US); Susan L. Havre, Richland, WA (US); Kenneth A. Perrine, Richland, WA (US); Elizabeth R. Jurrus, Kennewick, WA (US); Lucy T. Nowell, Richland, WA (US)

Correspondence Address: WELLS ST. JOHN P.S., 601 W. FIRST, SUITE 1300, SPOKANE, WA, 99201-3828, US

(21) Appl. No.: 09/755,503

(22) Filed: Jan. 5, 2001

(51) Int. Cl. G06F 17/00

(52) U.S. Cl. 707/3; 707/100

(57) ABSTRACT

Multi-query data visualization processes, data visualization apparatus, computer-readable media and computer data signals embodied in a transmission medium are provided. According to one aspect of the present invention, a multi-query data visualization process includes inputting a plurality of query objects into a data processing device and identifying features within each of the plurality of query objects that allow comparison to a body of data stored in a database. The process further includes determining relative relationships between each of the plurality of query objects and the body of data and displaying points along a plurality of rays, wherein a position of each of the displayed points corresponds to the determined relative relationship between each respective one of the plurality of query objects and the body of data.

This application is related to U.S. Pat. No. 6,070,133, entitled “Information Retrieval System Utilizing Wavelet Transform”, issued to M. E. Brewster and N. E. Miller on May 30, 2000 and filed on Jul. 21, 1997, which patent is hereby incorporated herein by reference for its teachings.

### TECHNICAL FIELD

The present invention relates to multi-query data visualization processes, data visualization apparatus, computer-readable media and computer data signals embodied in a transmission medium.

### BACKGROUND OF THE INVENTION

Some conventional information visualization and retrieval systems provide visualizations related to documents or their attributes by representing documents or a group of documents with graphical symbols. Search techniques for identifying a group of documents or portions of documents relative to some set of search criteria have been developed. Most of these techniques also provide some indicia of relevance for each element harvested by the search.

Examples of search techniques and relevancy evaluation tools are discussed, for example, in “Evaluation of a Tool for Visualization of Information Retrieval Results” by A. Veerasamy and N. Belkin, ACM catalogue no. 0-89791-792-8/96/08. This paper discusses a variety of information retrieval strategies and relationships between the search technique and the relevance or interpretation of search results. In general, searches tend to include an initial phase, during which search strategy is “fine-tuned”, and a second phase, in which specific items are harvested using the fine-tuned search strategy.

In the first phase, interpretation of search results is critical to successful and efficient modification of search strategy in order to try to optimize retrieval of data of particular relevance to a topic of interest. As the amount of data being searched increases, it is increasingly difficult and time-consuming to examine individual documents or portions of documents in order to assess relative relevance to an inquiry. It may also be increasingly difficult to understand relationships between the query, the search tool being employed and the information produced by the search tool. As a result, search results have been organized in a variety of different ways to try to make selected indicia available to the searcher in order to facilitate comprehension of the search results.

For example, various types of frequency data may be coupled to specific query elements or search results. As is discussed in the abovenoted article, many search engines will display a list of surrogates (e.g., title, source, author) of the top n-many retrieved items, together with some ranking for each. Such systems do not necessarily provide a clear understanding of why the particular list of items was retrieved, how elements within the list were ranked or how to improve query formulation to arrive at a possibly better set of retrieved data.

As the information-handling capacity of data manipulation systems increases, more and more data, running from abstracts to full-text displays, can be provided to the user as the user attempts to focus the search results on the topic of interest. However, this can result in increased search time at the first phase of a search, without necessarily improving the search results or understanding of the relationship between the search criteria and the search results.

The types of search tools generally in use allow a relatively complex query to be formulated and are able to provide indicia regarding relevance of search results to components of the query. However, these tools do not lend themselves to simultaneous multiple complex queries and collective interpretation of results from such queries.

Accordingly, there is need for visualization systems which provide clear and concise representations of search results that facilitate intuitive understanding of relationships between the search results, the search tool being employed and the queries giving rise to the search results.

### SUMMARY OF THE INVENTION

According to one aspect of the present invention, a multi-query data visualization process includes inputting a plurality of query objects into a data processing device and identifying features within each of the plurality of query objects that allow comparison to a body of data stored in a database. The process also includes determining relative relationships between each of the plurality of query objects and the body of data and displaying points along a plurality of rays. Positions of the displayed points correspond to the relative relationships.

A second aspect of the present invention provides data visualization apparatus including an image device configured to provide a visual image and digital processing circuitry coupled with the image device. The processing circuitry is configured to input a plurality of query objects and to identify features within each of the plurality of query objects that allow comparison to a body of data stored in a database. The processing circuitry is further configured to determine relative relationships between each of the plurality of query objects and the body of data and to control the image device to depict points corresponding to data from the database along each of a plurality of rays. Positions of the displayed points correspond to the relative relationships.

Another aspect of the invention provides computer usable code. The computer usable code is configured to cause digital processing circuitry to identify features of each of a plurality of query objects that allow comparison to a body of data stored in a database and to determine relative relationships between each of the plurality of query objects and the body of data. The computer usable code is also configured to control an image device to depict points corresponding to data from the database along each of a plurality of rays. Positions of the displayed points correspond to the relative relationships.

A further aspect of the present invention includes a computer data signal embodied in a transmission medium. The signal includes computer usable code configured to input a plurality of query objects into a data processing device and to determine relative relationships between each of the plurality of query objects and a body of data stored in a database. The signal also includes computer usable code configured to control an image device to depict points corresponding to data from the database along each of a plurality of rays. Positions of the displayed points correspond to the relative relationships.

### BRIEF DESCRIPTION OF THE DRAWINGS

Preferred embodiments of the invention are described below with reference to the following accompanying drawings.

FIG. 1 is a perspective view of an exemplary data visualization apparatus comprising a digital computer, in accordance with an embodiment of the present invention.

FIG. 2 is a functional block diagram of exemplary components of the data visualization apparatus of FIG. 1, in accordance with an embodiment of the present invention.

FIG. 3 shows an exemplary visual representation corresponding to II exemplary data shown upon an imaging medium of an appropriate image device, in accordance with an embodiment of the present invention.

FIG. 4 is a graphical representation of an exemplary search results display depicted using the digital computer following reorganization of the data in response to user input, in accordance with an embodiment of the present invention.

FIG. 5 shows another exemplary visual representation of the exemplary search results shown in the visual representation of FIGS. 3 and 4, in accordance with an embodiment of the present invention.

FIG. 6 shows an exemplary visual representation corresponding to another form of multi-query based on different forms of similarity to a given graphical object, representing a query or hypothesis, in accordance with an embodiment of the present invention.

FIG. 7 is a flow chart illustrating an exemplary process to depict data, in accordance with an embodiment of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

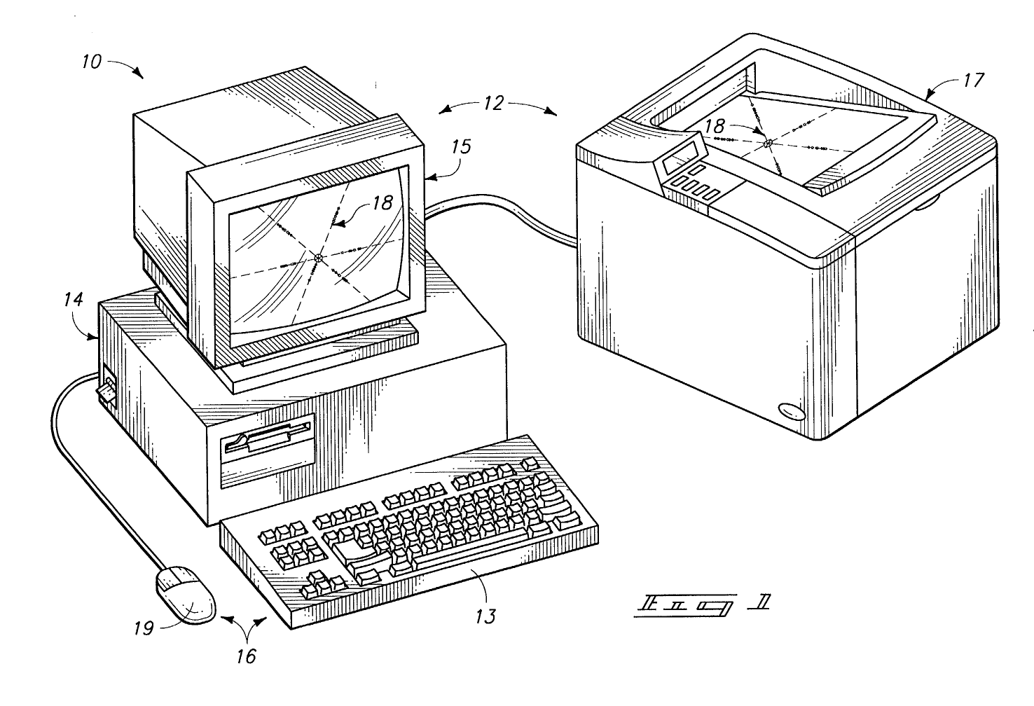

Referring to FIG. 1, a data visualization apparatus 10 is illustrated, in accordance with an embodiment of the present invention. The depicted data visualization apparatus 10 is implemented as a digital computer such as an Ultra 10 elite 3D workstation available from Sun Microsystems Inc. in one exemplary embodiment. Software utilized by the apparatus 10 includes mathematical, analytical and graphical software such as Rogue Wave Software Object-Oriented Libraries including Tools.h++ (Version 7), Math.h++ (Version 6), LAPACK.h++ (Version 2), and Analytics.h++ (Version 1) and software graphics package OpenGL™ available from Silicon Graphics, Inc. Other alternatives are possible. The depicted data visualization apparatus 10 is configured to operate under a multi-user, multi-tasking operating system, such as UNIX™. Other configurations of data visualization apparatus 10 are provided in other embodiments.

As shown, data visualization apparatus 10 includes a plurality of image devices 12, a housing 14 and a user interface 16. Image devices 12 are individually configured to visually depict data such as visual representation 18 described in detail below. Exemplary image devices 12 comprise a monitor 15 and a printer 17. Image devices 12 comprise other devices configured to depict data in other embodiments. Exemplary devices of user interface 16 include a keyboard 13 and a mouse 19 as shown.

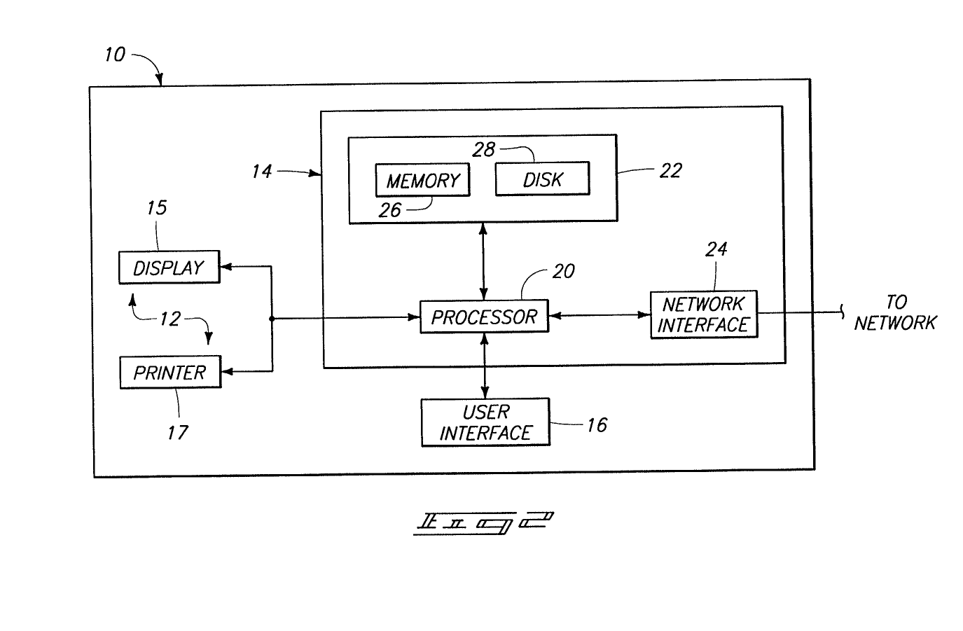

FIG. 2 is a functional block diagram of exemplary components of the data visualization apparatus 10 of FIG. 1, in accordance with an embodiment of the present invention. In particular, housing 14 is configured to house a processor 20, a plurality of storage devices 22 and a network interface 24. In the illustrated configuration, storage devices 22 include memory 26 and disk storage device 28. Storage devices 22 comprise computer usable media configured to store computer usable code and data. Exemplary memory 26 includes random access memory (RAM) and read only memory (ROM). Exemplary disk storage devices 28 include floppy disks and hard disks. Other storage devices such as a CD-ROM device are utilized in other configurations.

An exemplary network interface 24 comprises a network interface card configured to couple with an external network such as a public switched telephone network, a packet switched network, such as the Internet etc.

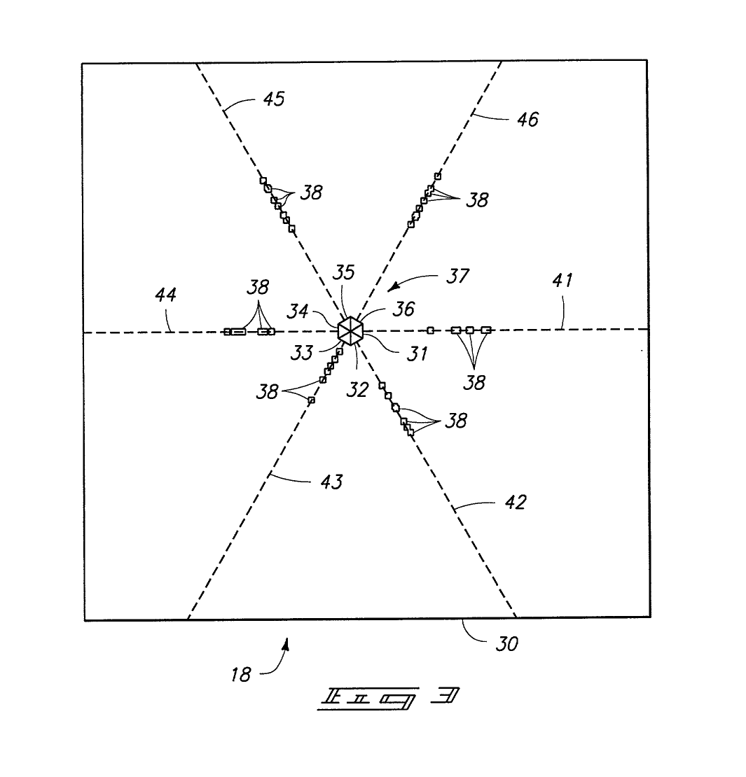

Data visualization apparatus 10 is configured to access data and visually depict such data organized as the visual representation 18 (FIGS. 1 and 3) with respect to a plurality of query objects and/or events using the image devices 12 in the described embodiment. In the depicted configuration, the visual representation 18 portrays multiple documents or information organized along vectors or rays extending outwardly from a common origin or locus. As used herein, the term “ray” is defined to mean a geometric construct having an origin and a direction, and may correspond to a linear or non-linear construct, such as a spiral, or which may be a directed region of space or volume, such as a half-plane or a curved planar surface. The rays represent the possible variance in relative relationship between the plurality of query objects and the body of data. Documents are illustrated as points spaced apart from the common origin or locus by varying distances. The common origin or locus is representative of the limit of the relative relationships.

The processor 20 comprises digital processing circuitry and is coupled with the image devices 12. The processor 20 is configured to access data from the storage devices 22, the network interface 24 and the user interface 16. The processor 20 is configured to generate the visual representation 18 corresponding to documents, references and/or events within the accessed data as described in detail below. The processor 20 further controls the image devices 12 to depict the visual representation 18 corresponding to the accessed data.

FIG. 3 shows an exemplary visual representation 18 corresponding to exemplary data shown upon an imaging medium 30 of an appropriate image device 12, in accordance with an embodiment of the present invention. The imaging medium 30 is suitable to visually depict the visual representation 18 and in exemplary configurations comprises paper for a printer image device 17 (FIG. 1), a display screen of a monitor image device 15 etc. Other types of imaging media 30 may be used in other embodiments.

FIG. 3 also shows six query objects or inquiries 31-36 grouped about a central point or locus 37. Multiple documents or information each represented by points 38 are organized along rays 41-46 arranged about the central point 37. The rays 41-46 extend outwardly from the common origin or locus 37 where a distance separating each document 38 from the common origin or locus 37 representing the query objects 31-36 represents a degree of similarity or lack thereof with respect to the hypotheses or query objects 31-36. While the rays 41-46 are represented as six rays equiangularly spaced about the locus 37, it will be appreciated that more or fewer query objects 31-36 could be employed, and that the rays 41-46 need not be equiangularly spaced about the locus 37.

The depicted data elements 38 may corresponds to the occurrence of particular items (e.g., country names, agricultural products, political movements, legal precedents, technical topics or keywords, image characteristics etc.) within a body of data, for example. Any type of data may be depicted within the visual representation 18. Types of data that may be analyzed include, for example, images corresponding to tissue samples, micrographs of metal samples, fingerprints or other biometric indicia, or word processing or text-containing files corresponding to legal cases, patent and/or technical publication databases, web documents, audio files of human speech or any other type of data that may be organized into a database.

As used herein, the term “query” is defined to mean an information object to be compared to objects in a database. A query could be one or more words, an image, results of a simulation, a color, a web page, a document, a sound file containing an audio conversation etc. The user is interested in the relative relation between the query and the data in the database. The relationship of interest may include similarity, containment, antithesis, shared attribute etc. The query may be the same kind of entity as the data in the database (for example, using a document as a query to be compared to WWW documents), or it may be different (for example, if the query is a color, and the goal is to find images containing that color). In another example, the query is a scenario and the objects 38 are extracted facts that match elements of the scenario.

The queries may be generated by a single individual or may be generated by multiple people working in a team-oriented or collaborative environment. Thus, for example, FIG. 3 might represent a method for exploring how six different people's viewpoints relate to the information in the database.

Examples of systems intended to assign numerical surrogates facilitating vector representation for attributes of data within a database in order to promote analysis of bodies of data and data extraction or document retrieval from of bodies of data are described in U.S. Pat. No. 5,553,226, entitled “System For Displaying Concept Networks” and issued to Kiuchi et al.; U.S. Pat. No. 5,950,196, entitled “System And Methods For Retrieving Tabular Data From Textual Sources” and issued to Pyreddy et al.; U.S. Pat. No. 5,659,732, entitled “Document Retrieval Over Networks Wherein Ranking And Relative Scores Are Computed At The Client For Multiple Database Documents” and issued to Kirsch; U.S. Pat. No. 5,826,261, entitled “System And Method For Querying Multiple, Distributed Databases By Selective Sharing Of Local Relative Significance Information For Terms Related To The Query” and issued to Spencer, which patents are hereby incorporated herein by reference for their teachings.

An exemplary system for carrying out similar sorting and identification with respect to multimedia data is described in U.S. Pat. No. 5,873,080, entitled “Using Multiple Search Engines To Search Multimedia Data” and issued to Coden et al., which patent is hereby incorporated herein by reference for its teachings. An example of a system for examining groups of documents and for providing two-dimensional displays related thereto is described in U.S. Pat. No. 5,625,767, entitled “Method And System For Two-Dimensional Visualization Of An Information Taxonomy And Of Text Documents Based On Topical Content Of The Documents” and issued to Bartell et al., which patent is hereby incorporated herein by reference for its teachings. Other tools that may be usefully employed include vector space models and statistical natural language processing techniques.

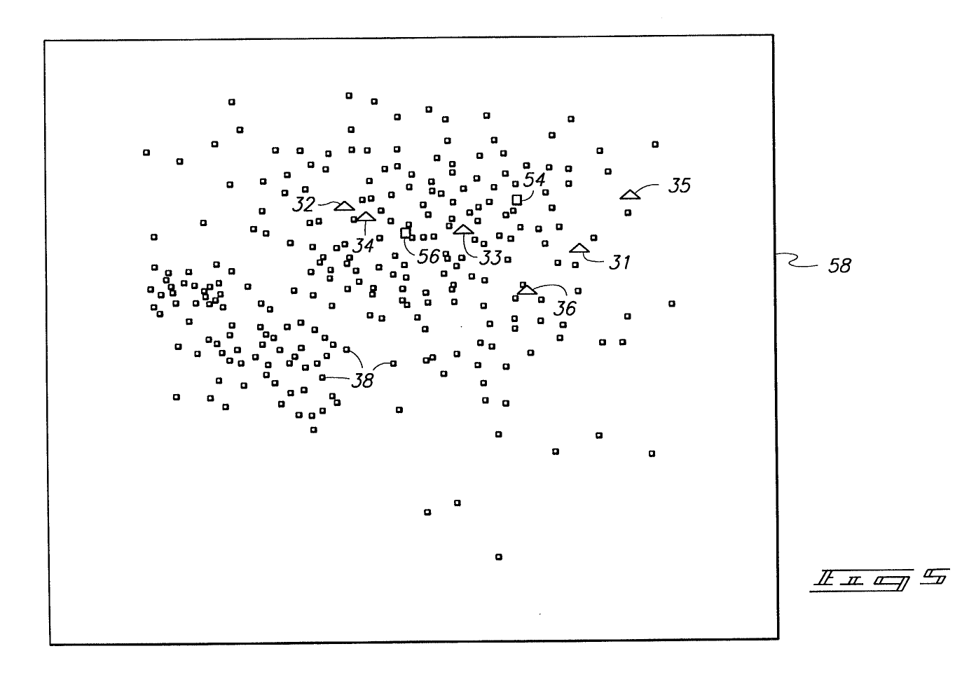

Another example of a system for facilitating human interaction with large bodies of information is the Spatial Paradigm for Information Retrieval and Exploration program developed at the Pacific Northwest Laboratory in Richland Wash. and described, for example, in “Visualizing The Non-Visual: Spatial Analysis And Interaction With Information From Text Documents”, published in Proceedings of IEEE '95 Information Visualization, pages 51-58, Atlanta Ga., October 1995, available through the IEEE Service Center, and hereby incorporated herein by reference for teachings on information processing and display. The SPIRE™ browsing system supports two-dimensional displays of data (e.g., the Galaxy display, similar to FIG. 5, infra) that have been processed to provide feature vector data according to thematic content.

The depicted visual representation 18 graphically presents the relationship of each data object 38 in a database to each of the query objects 31-36. The relationship of each data object 38 to a specific query object is indicated by the placement of a point representing the data object 38 along a single ray such as 41 corresponding to the query object 31. The proximity of a point along the ray to the locus 37 indicates the strength of the relationship between the query object and the data object represented by the point. In the current embodiment, the closer the point 38 is to the locus 37, the more similar the data object 38 is to the ray's query object. In one embodiment, two-dimensional representations of n-dimensional vectors are prepared using Sammon mapping, as is known in the art. Sammon mapping and other cluster-mapping techniques for representation of n-dimensional vectors in a two-dimensional space are discussed, for example, in U.S. Pat. No. 5,897,627, entitled “Method Of Determining Statistically Meaningful Rules” and issued to Leivian et al. and U.S. Pat. No. 5,891,729, entitled “Method For Substrate Classification” and issued to Behan et al., which patents are hereby incorporated herein by reference for their teachings.

Additional techniques for mapping data are discussed in U.S. Pat. No. 6,031,537, entitled “Method And Apparatus For Displaying A Thought Network From A Thought's Perspective” and issued to Hugh; U.S. Pat. No. 6,076,088, entitled “Information Extraction System And Method Using Concept Relation Concept (CRC) Triples” and issued to Paik et al.; U.S. Pat. No. 6,026,388, entitled “User Interface And Other Enhancements For Natural Language Information Retrieval System And Method” and issued to Liddy et al.; and U.S. Pat. No. 5,576,954, entitled “Process For Determination Of Text Relevancy” and issued to Driscoll, which patents are hereby incorporated herein by reference for their teachings.

Query objects 31-36 in accordance with the present invention can take many forms. Query objects 31-36 may correspond to situations where the user does not know much about the expected results, but does know what form a relevant response might take. In this case, the interaction of the user with the database is similar to a conventional search, such as a Boolean keyword search.

Query objects 31-36 may represent efforts to browse an information space. In this instance, the user is looking for something, but does not know what the result might look like. Query objects 31-36 may also represent attempts to “reality test” an idea or concept. In this case, the user has a mental model of the content some part of the database, but would like to determine whether the data supports or refutes that the mental model has validity.

Examples of types of query objects or hypotheses 31-36 that the user might be interested in may include trying to locate legal precedents for a given fact pattern, trying to locate patents or technical publications relating to a type of device, process or model, searching for information in political speeches, government reports and the like, searching for information regarding chronological developments on a given topic, searching for a subset of images including a some specific type of image or data, searching a series of broadcasts for specific speech patterns, jingles or content or any other form of organized search of a body of data.

The processor 20 controls the image device 12 to arrange the visual representation 18 relative to a central locus 37. The locus 37 may be provided at other locations relative to the visual representation 18 in other arrangements. Further, the locus 37 may be depicted or not shown at all in particular configurations of the visual representation 18.

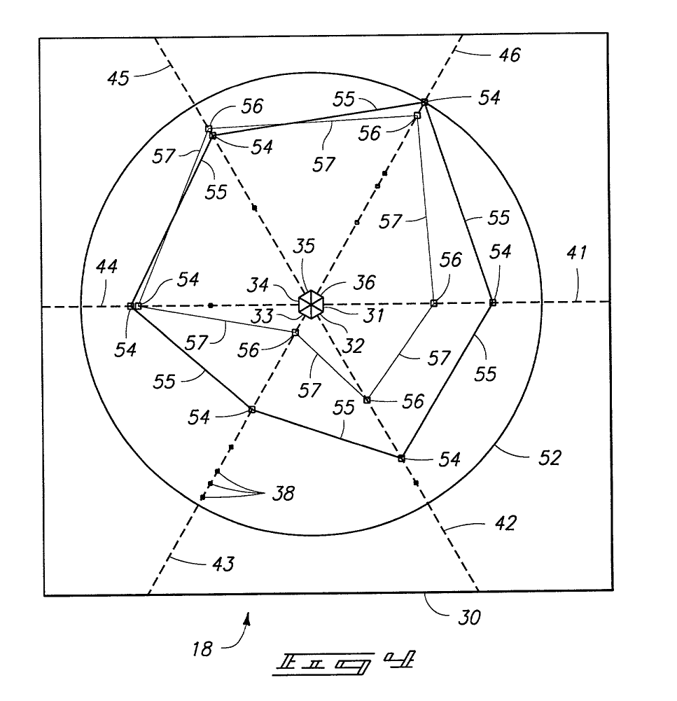

FIG. 4 is a graphical representation of exemplary search results in visual representation 18 depicted using the digital computer following specification of a relevance threshold 52 in response to user input, in accordance with an embodiment of the present invention. The processor 20 (FIG. 2) is configured to display the rays 41-46 corresponding to user-input query objects 31-36 and to determine relative relationships between the points 38 distributed along the rays 41-46 and data stored in the database and to then represent a subset of the data having relevance to the query objects as points 38 distributed along the vectors 41-46 within the relevance threshold 52. In one embodiment, the relevance threshold 52 is represented by a circle or other geometric shape formed about the common origin 37.

In one embodiment, the user is able to gauge a probable relevance of data represented by a given point, e.g., point 54, found along one of the rays 41-46, e.g., 43, by noting a distance separating the given object, e.g., that represented by the point 54, from the common origin 37. The s object corresponding to the point 54 actually has similar relevance to each of the query objects 31-36 as shown by the arcs 55 coupling the representation of the object 54 on the ray 43 to representations of the object 54 on others of the rays 41, 42 and 44-46. In the example of FIG. 4, the user has requested that the system show all points falling within the relevance threshold 52 for all queries. In this instance, only two objects, represented by the points 54 and 56, meet this criteria. Representations of the object 56 on each of the rays 41-46 are interconnected by arcs 57.

In one embodiment, the user may select one of the objects corresponding to the points 54 and 56, e.g., point 54. The selection can be made, for example, using a tactile feedback input device such as a mouse or keyboard (e.g., using arrow keys or the tab key, followed by the enter key). In response to user selection of the given point 54, a display of data relating to the object corresponding to the given point 54 is provided. The display may include information such as author, frequency tables for occurrence of selected terms in the query, probable status for the object corresponding to the point 54 vis-a-vis the query 33 occurring within the object, confidence factor and the like.

For example, in one embodiment, the user may be provided with a text display corresponding to a document represented by the given point 54. In one embodiment, a separate image device displays text corresponding to the document represented by the given point 54. In one embodiment, the user may be provided with a text file corresponding to a portion of a document where the portion has been determined to be that portion of the document that includes reference to a specific theme or idea.

In one embodiment, the user may request all objects within the specified distance of all but one of the query objects 31-36, or all but two etc., and to then obtain a display of the ensemble of objects after re-calculation of relative relationships between the query objects 31-36 and the collection of objects in the database. In one embodiment, the user may select (e.g., click on) one or more of the queries to turn that query off and to then obtain a display of the ensemble of points after re-calculation of relative relationships between the query objects 31-36 and the collection of objects in the database.

FIG. 5 shows another exemplary visual representation 58 of the exemplary search results shown in the visual representation 18 of FIGS. 3 and 4, in accordance with an embodiment of the present invention. In FIG. 5, relative distance represents similarity or lack thereof between distinct points of the representation 58. For example, one method of placing the points (e.g., 38, 31-36, 54) is to use Sammon projection or other multidimensional scaling methods, as described in “Multivariate Analysis” by K. V. Mardia, J. T. Kent and J. M. Bibby, Academic Press Ltd., London, U.K., 1979 (ISBN 0-12-471252-5), which is hereby incorporated herein by reference for its teachings. In one embodiment, the similarity between the query objects and the data in the database is weighted more strongly in determining the positions of points 38 than the similarity among data in the database. In one embodiment, the user may control the weighting scheme, to modify the amount of weighting or to limit it to only some of the query objects 31-36 or some of the database objects. The representations 18 and 58 are linked so that elements (e.g., 31-36, 54, 56) selected in one of the representations 18, 58 also are selected in the other of these representations 18 and 58.

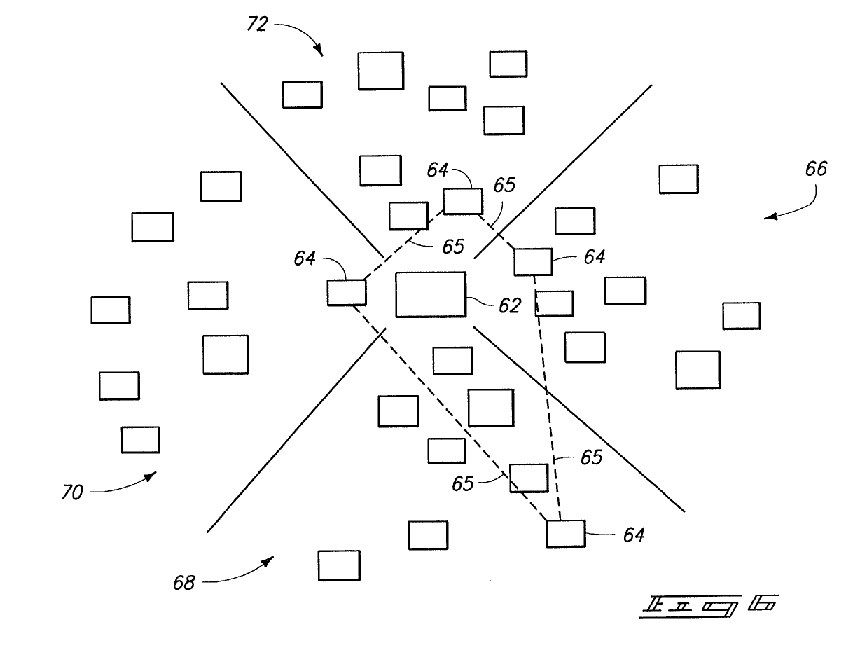

FIG. 6 shows an exemplary visual representation 60 corresponding to another form of multi-query based on different forms of similarity to a given graphical object 62, representing a query or hypothesis, in accordance with an embodiment of the present invention. FIG. 6 shows examples of a nearest match 64 interconnected by dashed lines 65 and appearing in each of four different regions 66-72, where each region 66-72 corresponds to an attribute such as black/white mix content, curve content, horizontal component content or spatial frequency content. The object 62 could represent a tissue sample, a metallurgical micrograph, biometric image data or any other type of image data.

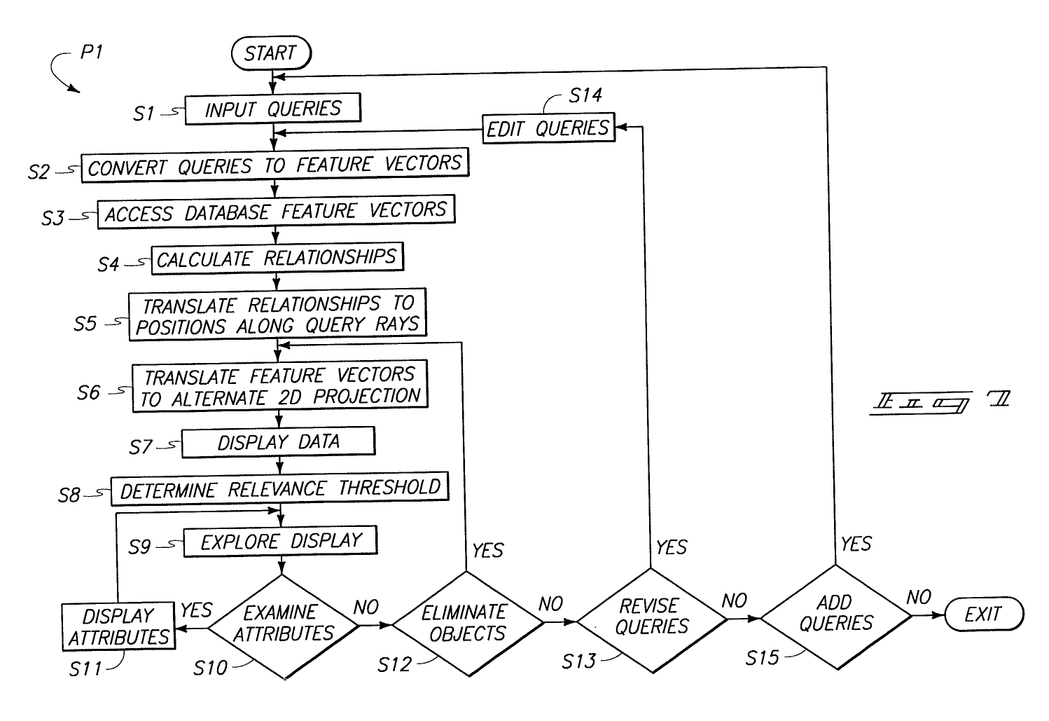

FIG. 7 is a flow chart illustrating an exemplary process P1 to depict data, in accordance with an embodiment of the present invention.

Initially, the processor 20 (FIG. 2) executes a set-up procedure. For example, the processor 20 creates a window having a menu bar and/or a drawing area within the imaging medium of an appropriate image device 12.

The process P1 then proceeds to a step S1. In the step S1, the user enters a set of query objects 31-36.

In a step S2, the query objects 31-36 are converted to n-dimensional feature data. Conversion to vector data may be carried out using any appropriate algorithm, with the type of algorithm needed being determined in part by the nature of the data forming the query objects 31-36.

Next, the processor 20 proceeds to a step S3 to access data objects to be visually depicted by the image device 12. Such data objects typically include references, events or images. In one embodiment, the data consist of entire images or documents. In one embodiment, the data are processed to determine boundaries of portions of data elements, such as documents that are relevant to one or more topics, and the data are broken down into subsets, some of which will be more relevant than others to any given query. In the current embodiment, the feature vectors have already been calculated for the data objects in 38 in the database and are merely accessed in this step. In an alternate embodiment, feature vectors for the data objects 38 could be created or modified based on the queries input in the step S1.

In a step S4, the n-dimensional feature vectors of the data objects and the query objects are compared to one another. The step S4 determines relationships between each of the data objects 38 in the database and the query objects 31-36.

In a step S5, the processor 20 projects the relationships calculated in the step S4 to points along the query rays as seen in FIG. 3. The plurality points along each query ray corresponds to the elements 38. The plurality of query rays corresponds to the query objects 31-36.

In a step S6, the processor 20 may optionally reduce the n12 dimensional feature vectors of the data objects and the query objects to two- or three- dimensional vectors or points in an alternate projection. In one embodiment, the data object and the query object feature vectors are converted to two-dimensional points using a Sammon mapping as seen in FIG. 5.

In a step S7, the processor 20 causes the projected points representing the data objects 38 and the query objects 31-36 to be displayed on one of the display devices 12. In one embodiment, displays of the rays depicting relationships between the data objects and the query objects such as that of FIG. 3 are shown. In one embodiment, displays with alternate projections such as that of FIG. 5 are shown.

In a step S8, a relevance threshold is determined. In one embodiment, this results in a display such as that of FIG. 4. In one embodiment, the relevance threshold 52 is set by a user. In one embodiment, the relevance threshold 52 is set according to predetermined characteristics. In one embodiment, the relevance threshold is user-adjustable.

In a step S9, a user examines the displayed data. The user may select one or more of the formats illustrated in FIGS. 3-5, or may flip from one display type to another.

In a query task S10, the process P1 determines when the user wishes to examine attributes of a given point 38 in a display in more detail. When the user wishes to examine attributes of the given point in more detail, control passes to a step S11. When the user does not wish to examine attributes of any points 38 in more detail, or when the user has completed this process, control passes to a query task S12.

When the user wishes to examine attributes of a given point 38 in more detail, the user may select a limited amount of information (e.g., author, keyword frequency, limited text portions or the like) or more comprehensive information (e.g., a full text version of an object or a detailed image of an object) in the step S11. Control then passes back to the step S9.

In the query task S12, the process P1 determines when the user wishes to eliminate one or more of the objects 54 or 56. When the user does not wish to eliminate any elements, the process P1 passes control to a query task S13. When the user does wish to alter or eliminate one or more of the objects such as 54, control passes back to the step S6.

In the query task S13, the process P1 determines when the user wishes to alter or remove one or more of the query objects 31-36. When the user wishes to alter one or more of the query objects 31-36, the process P1 passes control to a step S14. When the user does not wish to alter or remove one or more of the query objects 31-36, the process P1 passes control to a query task S15.

In the step S14, the user alters or removes one or more of the query objects 31-36. The process P1 then passes control back to the step S2.

In the query task S15, the process P1 determines when the user wishes to add one or more new queries. When the user does not wish to add any new queries, the process P1 ends. When the user wishes to add one or more new queries, the process P1 passes control back to the step S1.

The processor 20 is configured in one embodiment to adjust control of the data visualization apparatus 12 responsive to input from a user via the user interface 16, via the network interface 24, or other modes. For example, a user may request new data, new time or reference resolution, a curve type for the components, a change in the order of the components or may select or deselect objects with reference to specific ones of the query objects 31-36 or all of them etc. The processor 20 is configured to re-execute appropriate portions of the process P1 responsive to such changes or requests from a user.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A multi-query data visualization process comprising:
inputting a plurality of query objects into a data processing device;
identifying features within each of the plurality of query objects that allow comparison to a body of data stored in a database;
determining relative relationships between each of the plurality of query objects and the body of data; and
displaying points along a plurality of rays, wherein a position of each of the displayed points corresponds to the determined relative relationship between each respective one of the plurality of query objects and the body of data.

2. The process of claim 1, wherein displaying includes placing a small graphic entity at an end of each of the plurality of rays to represent a respective one of the plurality of query objects.

3. The process of claim 1, wherein displaying includes locating the plurality of rays to have a common origin.

4. The process of claim 3, wherein displaying includes locating the plurality of rays to radiate outwardly from the common origin at equally-spaced angles from one another.

5. The process of claim 1, wherein displaying includes locating the plurality of rays to have a common origin and further comprising determining a critical distance from the common origin, wherein points on the plurality of rays falling within the critical distance meet or exceed a relevancy threshold and points on the plurality of rays outside the critical distance do not meet the relevancy threshold.

6. The process of claim 5, further comprising adjusting the critical distance in response to user input.

7. The process of claim 1, further comprising:
re-determining relative relationships between each of the plurality of query objects and the body of data in response to user input; and
rearranging the positions of the displayed points in response to redetermining.

8. The process of claim 1, further comprising:
deleting an element from the body of data in response to user input;
re-determining relative relationships between each of the plurality of query objects and the body of data in response to deleting; and
rearranging the positions of the displayed points in response to re-determining.

9. The process of claim 1, wherein determining comprises accessing data corresponding to the occurrence of textual information within a plurality of documents and displaying comprises depicting usage of the textual information within the documents corresponding to portions of the plurality of query objects.

10. The process of claim 1, wherein determining comprises:
organizing data in the database and the plurality of query objects in an n-dimensional space; and
reducing a number n of dimensions in which the data in the database and the plurality of query objects are organized to two dimensions using a Sammon projection.

11. The process of claim 1, wherein identifying comprises representing each of the plurality of query objects and each datum in the body of data as an n-dimensional vector in an n-dimensional vector space.

12. The process of claim 11, wherein determining comprises calculating a similarity measure between each of the plurality of query objects and each datum of the body of data using some portion of the n-dimensional vectors.

13. The process of claim 12, wherein determining further comprises:
reducing a number n of dimensions in which the body of data and the query objects are represented to three or fewer dimensions using a multi-dimensional scaling method, where the similarity measures between each of the plurality of query objects and the body of data are weighted more heavily than the similarity measures among data within the body of data; and
wherein displaying comprises displaying points corresponding to the plurality of query objects and points corresponding to the body of data according to the three or fewer dimensions.

14. The process of claim 1, wherein displaying further comprises displaying points corresponding to data from the database along each of the plurality of rays in a two dimensional display, wherein positions of the displayed points correspond to the relative relationships.

15. The process of claim 1, wherein determining comprises:
determining thematic boundaries within each element contained in the database;
breaking elements into subelements at the determined thematic boundaries;
determining relative relationships between each of the plurality of query objects and the subelements; and
displaying points corresponding to the subelements along each of the plurality of rays, wherein positions of the displayed points correspond to the relative relationships.

16. The process of claim 1, wherein determining comprises:
breaking elements into subelements;
determining relative relationships between each of the plurality of query objects and the subelements; and
displaying points corresponding to the subelements along each of the plurality of rays, wherein positions of the displayed points correspond to the relative relationships.

17. A data visualization apparatus comprising:
an image device configured to provide a visual image; and
digital processing circuitry coupled with the image device and configured to:
input a plurality of query objects;
identify features within each of the plurality of query objects that allow comparison to a body of data stored in a database;
determine relative relationships between each of the plurality of query objects and the body of data; and
control the image device to depict points corresponding to data from the database along each of a plurality of rays, wherein positions of the displayed points correspond to the relative relationships.

18. The data visualization apparatus of claim 17, wherein the digital processing circuitry configured to display includes digital processing circuitry configured to display a small graphic entity at an end of each of the plurality of rays to represent a respective one of the plurality of query objects.

19. The data visualization apparatus of claim 17, wherein the digital processing circuitry configured to display includes digital processing circuitry configured to display the plurality of rays to have a common origin.

20. The data visualization apparatus of claim 19, wherein the digital processing circuitry configured to display includes digital processing circuitry configured to display the plurality of rays to radiate outwardly from the common origin at equally-spaced angles from one another.

21. The data visualization apparatus of claim 17, wherein the digital processing circuitry configured to display includes digital processing circuitry configured to display the plurality of rays to have a common origin and further comprising digital processing circuitry configured to determine a critical distance from the common origin, wherein points on the plurality of rays falling within the critical distance meet or exceed a relevancy threshold and points on the plurality of rays outside the critical distance do not meet the relevancy threshold.

22. The data visualization apparatus of claim 21, wherein the digital processing circuitry is further configured to adjust the critical distance in response to user input.

23. The data visualization apparatus of claim 17, wherein the digital processing circuitry is further configured to:
re-determine relative relationships between each of the plurality of query objects and the body of data in response to user input; and
control the image device to rearrange positions of the displayed points in response to the re-determined relationship.

24. The data visualization apparatus of claim 17, wherein the digital processing circuitry is further configured to:
delete an element from the body of data in response to user input;
re-determine relative relationships between each of the plurality of query objects and the body of data in response to deleting; and
control the image device to rearrange the positions of the displayed points in response to re-determining.

25. The data visualization apparatus of claim 17, wherein the digital processing circuitry configured to determine comprises digital processing circuitry configured to access data corresponding to the occurrence of textual information within a plurality of documents and the digital processing circuitry configured to control the image device comprises digital processing circuitry configured to depict usage of the textual information corresponding to portions of the query objects appearing within the documents via the image device.

26. The data visualization apparatus of claim 17, wherein the digital processing circuitry configured to determine comprises digital processing circuitry configured to:
organize data in the database and the plurality of query objects in an n-dimensional space; and
reduce a number n of dimensions in which the data in the database and the plurality of query objects are organized to two dimensions using a Sammon projection.

27. The data visualization apparatus of claim 17, wherein the digital processing circuitry configured to identify comprises digital processing circuitry configured to represent each of the plurality of query objects and each datum in the body of data as an n-dimensional vector in an n-dimensional vector space.

28. The data visualization apparatus of claim 27, wherein the digital processing circuitry configured to determine comprises digital processing circuitry configured to calculate a similarity measure between each of the plurality of query objects and each datum of the body of data using some portion of the n-dimensional vectors.

29. The data visualization apparatus of claim 28, wherein the digital processing circuitry configured to determine further comprises digital processing circuitry configured to:
reduce a number n of dimensions in which the body of data and the query objects are represented to three or fewer dimensions using a multi-dimensional scaling method, where the similarity measures between each of the plurality of query objects and the body of data are weighted more heavily than the similarity measures among data within the body of data; and
wherein the digital processing circuitry configured to display comprises digital processing circuitry configured to display points corresponding to the plurality of query objects and points corresponding to the body of data according to the three or fewer dimensions.

30. The data visualization apparatus of claim 17, wherein the digital processing circuitry configured to control the image device comprises digital processing circuitry configured to control the image device to display points corresponding to data from the database along each of the plurality of rays in two dimensions, wherein positions of the displayed points correspond to the relative relationships.

31. The data visualization apparatus of claim 17, wherein the digital processing circuitry configured to determine relative relationships comprises digital processing circuitry configured to:
determine thematic boundaries within each element contained in the database;
break elements into subelements at the determined thematic boundaries; and
determine relative relationships between each of the plurality of query objects and the subelements; and wherein the digital processing circuitry configured to control the image device to display points comprises digital processing circuitry configured to display points corresponding to subelements along each of the plurality of rays, wherein positions of the displayed points correspond to the relative relationships.

32. The data visualization apparatus of claim 17, wherein the digital processing circuitry configured to determine relative relationships comprises digital processing circuitry configured to:
break elements into subelements; and
determine relative relationships between each of the plurality of query objects and the subelements; and wherein the digital processing circuitry configured to control the image device to display points comprises digital processing circuitry configured to display points corresponding to subelements along each of the plurality of rays, wherein positions of the displayed points correspond to the relative relationships.

33. A computer-readable medium comprising computer usable code configured to cause digital processing circuitry to:
identify features of each of a plurality of query objects that allow comparison to a body of data stored in a database;
determine relative relationships between each of the plurality of query objects and the body of data; and
control an image device to depict points corresponding to data from the database along each of a plurality of rays, wherein positions of the displayed points correspond to the relative relationships.

34. The computer readable medium comprising computer usable code of claim 33, wherein the computer usable code configured to display includes computer usable code configured to display a small graphic entity at an end of each of the plurality of rays to represent a respective one of the plurality of query objects.

35. The computer readable medium comprising computer usable code of claim 33, wherein the computer usable code configured to display includes computer usable code configured to display the plurality of rays to have a common origin.

36. The computer readable medium comprising computer usable code of claim 35, wherein the computer usable code configured to display includes computer usable code configured to display the plurality of rays to radiate outwardly from the common origin at equally-spaced angles from one another.

37. The computer readable medium comprising computer usable code of claim 33, wherein the computer usable code configured to display includes computer usable code configured to display the plurality of rays to have a common origin and further comprising computer usable code configured to determine a critical distance from the common origin, wherein points on the plurality of rays falling within the critical distance meet or exceed a relevancy threshold and points on the plurality of rays outside the critical distance do not meet the relevancy threshold.

38. The computer readable medium comprising computer usable code of claim 37, wherein the computer usable code is further configured to adjust the critical distance in response to user input.

39. The computer readable medium comprising computer usable code of claim 33, wherein the computer usable code is further configured to:
re-determine relative relationships between each of the plurality of query objects and the body of data in response to user input; and
control the image device to rearrange the positions of the displayed points in response to the re-determined relationships.

40. The computer readable medium comprising computer usable code of claim 39, wherein the computer usable code is further configured to:
delete an element from the body of data in response to user input;
re-determine relative relationships between each of the plurality of query objects and the body of data in response to deleting; and
control the image device to rearrange the positions of the displayed points in response to re-determining.

41. The computer readable medium comprising computer usable code of claim 33, wherein the computer usable code configured to determine comprises computer usable code configured to access data corresponding to the occurrence of textual information within a plurality of documents and the computer usable code configured to control the image device comprises computer usable code configured to depict usage of the textual information within the documents that correspond to portions of the plurality of query objects.

42. The computer readable medium comprising computer usable code of claim 33, wherein the computer usable code configured to determine comprises computer usable code configured to:
organize data in the database and the plurality of query objects in an n-dimensional space; and
reduce a number n of dimensions in which the data in the database and the plurality of query objects are organized to two dimensions using a Sammon projection.

43. The computer readable medium comprising computer usable code of claim 33, wherein the computer usable code configured to identify comprises computer usable code configured to represent each of the plurality of query objects and each datum in the body of data as an n-dimensional vector in an n-dimensional vector space.

44. The computer readable medium comprising computer usable code of claim 43, wherein the computer usable code configured to determine comprises computer usable code configured to calculate a similarity measure between each of the plurality of query objects and each datum of the body of data using some portion of the n-dimensional vectors.

45. The computer readable medium comprising computer usable code of claim 44, wherein the computer usable code configured to determine further comprises computer usable code configured to:
reduce a number n of dimensions in which the body of data and the query objects are represented to three or fewer dimensions using a multi-dimensional scaling method, where the similarity measures between each of the plurality of query objects and the body of data are weighted more heavily than the similarity measures among data within the body of data; and
wherein the digital processing circuitry configured to display comprises digital processing circuitry configured to display points corresponding to the plurality of query objects and points corresponding to the body of data according to the three or fewer dimensions.

46. The computer readable medium comprising computer usable code of claim 33, wherein the computer usable code configured to control the image device comprises computer usable code configured to control the image device to display points corresponding to data from the database along each of the plurality of rays in two dimensions, wherein positions of the displayed points correspond to the relative relationships.

47. The computer readable medium comprising computer usable code of claim 33, wherein the computer usable code configured to determine comprises computer usable code configured to:
determine thematic boundaries within each element contained in the database;
break elements into subelements at the determined thematic boundaries; and
determine relative relationships between each of the plurality of query objects and the subelements; and wherein the computer usable code configured to control the image device comprises computer usable code configured to display points corresponding to subelements along each of the plurality of rays, wherein positions of the displayed points correspond to the relative relationships.

48. The computer readable medium comprising computer usable code of claim 33, wherein the computer usable code configured to determine comprises computer usable code configured to:
break elements into subelements; and
determine relative relationships between each of the plurality of query objects and the subelements; and wherein the computer usable code configured to control the image device comprises computer usable code configured to display points corresponding to subelements along each of the plurality of rays, wherein positions of the displayed points correspond to the relative relationships.

49. A computer data signal embodied in a transmission medium comprising computer usable code configured to:
input a plurality of query objects into a data processing device;
determine relative relationships between each of the plurality of query objects and a body of data stored in a database; and
control an image device to depict points corresponding to data from the database along each of a plurality of rays, wherein positions of the displayed points correspond to the relative relationships.

50. The signal according to claim 49, wherein the computer usable code configured to display includes computer usable code configured to display a small graphic entity at an end of each of the plurality of rays to represent a respective one of the plurality of query objects.

51. The signal according to claim 49, wherein the computer usable code configured to display includes computer usable code configured to display the plurality of rays to have a common origin.

52. The signal according to claim 51, wherein the computer usable code configured to display includes computer usable code configured to display the plurality of rays as radiating outwardly from the common origin at equally-spaced angles from one another.

53. The signal according to claim 49, wherein the computer usable code configured to display includes computer usable code configured to display the plurality of rays to have a common origin, and further comprising computer usable code configured to determine a critical distance from the common origin, wherein points on the plurality of rays falling within the critical distance meet or exceed a relevancy threshold and points on the plurality of rays outside the critical distance do not meet the relevancy threshold.

54. The signal according to claim 53, wherein the computer usable code is further configured to adjust the critical distance in response to user input.

55. The signal according to claim 49, wherein the computer usable code is further configured to:
re-determine relative relationships between each of the plurality of query objects and the body of data in response to user input; and
control the image device to rearrange the positions of the displayed points in response to the re-determined relative relationships.

56. The signal according to claim 49, wherein the computer usable code is further configured to:
delete an element from the body of data in response to user input;
re-determine relative relationships between each of the plurality of query objects and the body of data in response to deletion; and
control the image device to rearrange the positions of the displayed points in response to re-determining.

57. The signal according to claim 49, wherein the computer usable code configured to determine comprises computer usable code configured to access data corresponding to the occurrence of textual information within a plurality of documents and the computer usable code configured to control the image device comprises computer usable code configured to depict usage of the textual information within the documents that correspond to portions of the plurality of query objects.

58. The signal according to claim 49, wherein the computer usable code configured to determine comprises computer usable code configured to:
organize data in the database and the plurality of query objects in an n-dimensional space; and
reduce a number n of dimensions in which the data in the database and the plurality of query objects are organized to two dimensions using a Sammon projection.

59. The signal according to claim 49, wherein the computer usable code configured to control the image device comprises computer usable code configured to control the image device to display points corresponding to data from the database along each of the plurality of rays in two dimensions, wherein positions of the displayed points correspond to the relative relationships.

60. The signal according to claim 49, wherein the computer usable code configured to determine comprises computer usable code configured to:
determine thematic boundaries within each document contained in the database;
break documents into subdocuments at the determined thematic boundaries; and
determine relative relationships between each of the plurality of query objects and the subdocuments; and wherein the computer usable code configured to control the image device comprises computer usable code configured to display points corresponding to subdocuments along each of the plurality of rays, wherein positions of the displayed points correspond to the relative relationships.

61. The signal according to claim 49, wherein the computer usable code configured to determine comprises computer usable code configured to:
break documents into subdocuments; and
determine relative relationships between each of the plurality of query objects and the subdocuments; and wherein the computer usable code configured to control the image device comprises computer usable code configured to display points corresponding to subdocuments along each of the plurality of rays, wherein positions of the displayed points correspond to the relative relationships.

62. The signal according to claim 49, wherein the computer usable code configured to identify comprises computer usable code configured to represent each of the plurality of query objects and each datum in the body of data as an n-dimensional vector in an n-dimensional vector space.

63. The signal according to claim 62, wherein the computer usable code configured to determine comprises computer usable code configured to calculate a similarity measure between each of the plurality of query objects and each datum of the body of data using some portion of the n-dimensional vectors.

64. The signal according to claim 63, wherein the computer usable code configured to determine further comprises computer usable code configured to:
reduce a number n of dimensions in which the body of data and the query objects are represented to three or fewer dimensions using a multi-dimensional scaling method, where the similarity measures between each of the plurality of query objects and the body of data are weighted more heavily than the similarity measures among data within the body of data; and
wherein the digital processing circuitry configured to display comprises digital processing circuitry configured to display points corresponding to the plurality of query objects and points corresponding to the body of data according to the three or fewer dimensions.

65. A data visualization process comprising:
inputting a plurality of query objects into in a data processor;
determining relative relationships between each of the plurality of query objects and a body of data; and
displaying a point along each of a plurality of rays for each of the plurality of query objects, wherein positions of the displayed points correspond to the relative relationships between a respective one of the plurality of query objects and the body of data.

66. The data visualization process of claim 65, wherein displaying includes placing a small graphic entity at an end of each of the plurality of rays to represent a respective one of the plurality of query objects.

67. The data visualization process of claim 65, wherein determining relative relationships comprises determining relative relationships between each of the plurality of query objects and a body of data stored in a database in the data processor.

68. The data visualization process of claim 65, further comprising redetermining relative relationships in response to user input criteria.

69. The data visualization process of claim 65, wherein displaying comprises displaying the plurality of rays to have a common origin.

70. The data visualization process of claim 65, wherein displaying comprises displaying the plurality of rays to have a common origin and to radiate outwardly from the common origin at equally-spaced angles from one another.

71. The process of claim 69, further comprising determining a critical distance from the common origin, wherein points on the plurality of rays falling within the critical distance meet or exceed a relevancy threshold and points on the plurality of rays outside the critical distance do not meet the relevancy threshold.
